(19) United States
(12) Patent Application Publication
(10) Pub. No.: US 2025/0370255 A1
(43) Pub. Date: Dec. 4, 2025

(54) COMPUTING DEVICE AND METHOD FOR GENERATING LIGHT FIELD DATA DISPLAYABLE ON NEAR-EYE LIGHT FIELD DISPLAY

(71) Applicant: PetaRay Inc., New Taipei City (TW)

(72) Inventors: Yi-Chou Chen, Taipei (TW); Hong-Ming Chen, Taipei (TW)

(21) Appl. No.: 19/220,116

(22) Filed: May 28, 2025

Related U.S. Application Data
(60) Provisional application No. 63/654,167, filed on May 31, 2024.

(51) Int. Cl. G02B 27/00; H04N 13/128; H04N 13/282

(52) U.S. Cl. CPC G02B 27/0025; H04N 13/128; H04N 13/282

(57) ABSTRACT

A computing device and a method for generating light field data displayable on a near-eye light field display. The computing device includes one or more processing units, which are configured to generate target light field data from stereo images and make an angular sampling structure of the target light field data consistent with an internal angular sampling structure of the near-eye light field display, and compensate the target light field data for optical distortions of the near-eye light field display.

### CROSS-REFERENCE TO RELATED PATENT APPLICATION

This application claims the benefit of priority to the U.S. Provisional Patent Application Ser. No. 63/654, 167, filed on May 31, 2024, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a device and a method, and more particularly to a computing device and a method for generating light field data displayable on near-eye light field display.

### BACKGROUND OF THE DISCLOSURE

Light field display is considered to be the ultimate near-eye display technology because it offers natural 3D visual experiences to users by projecting light rays of virtual objects as if the light rays were emanated from real objects. Since the light field display is free of the notorious vergence-accommodation conflict that often causes discomfort and sometimes nausea to users, the user can comfortably navigate virtual objects in space and perceive a clear image of any object of interest.

Much 3D contents is already available in the form of stereo images. Repurposing such legacy contents for the ever-popular AR/VR necessitates view synthesis to convert stereo images to light field data.

While view synthesis for angularly-sparse light field data captured by a light field camera has been developed, such “camera-oriented” view synthesis techniques aim for the production of high-quality refocused images with shallow depth of field and natural image blur by augmenting as many angular samples as possible to the light field after it is captured. The refocused image rendered at a certain depth is presented to the viewer, and the refocusing is performed digitally. In contrast, “display-oriented” view synthesis aims for the production of light field to be taken as input to a light field display. The entire light field is projected to the viewer, and the refocusing is performed by the viewer's eyes.

As a result, display-oriented view synthesis is different from camera-oriented view synthesis in a number of aspects. For example, the display-oriented view synthesis has to have an angular sampling structure consistent with the specifications of the light field display. Because the light field display has a fixed number of pixels, the output of a display-oriented view synthesis typically is an angularly-sparse light field as opposed to an angularly-dense light field. The design of display-oriented view synthesis needs to take into consideration the ocular convergence and accommodation of the viewer. Since accommodation and vergence help the viewer to maintain a singular and focused visual experience while an object moves in depth, the perceived depth of the object represented by the light field has to match the focal distance of the viewer for realistic virtual-real integration, requiring that the structure of the light field to be displayed matches the optical characteristics of the light field display. For example, the angular sampling interval between adjacent subviews of a light field has to match the micro-projector baseline of the light field display, or an incorrect image may be perceived. These design requirements, however, are not taken into consideration in camera-oriented view synthesis.

### SUMMARY OF THE DISCLOSURE

In response to the above-referenced technical inadequacies, the present disclosure provides a computing device and a method for generating light field data from stereo images, and makes the light field data displayable on near-eye light field display.

In order to solve the above-mentioned problems, one of the technical aspects adopted by the present disclosure is to provide a computing device for generating light field data displayable on a near-eye light field display, in which the computing device includes one or more processing units. The one or more processing units are configured to: generate target light field data from stereo images and make an angular sampling structure of the target light field data consistent with an internal angular sampling structure of the near-eye light field display; and compensate the target light field data for optical distortions of the near-eye light field display.

In order to solve the above-mentioned problems, another one of the technical aspects adopted by the present disclosure is to provide a method for generating light field data displayable on a near-eye light field display, the method including: configuring one or more processing units to generate target light field data from stereo images and make an angular sampling structure of the target light field data consistent with an internal angular sampling structure of the near-eye light field display; and compensating the target light field data for optical distortions of the near-eye light field display.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following descriptions and the accompanying drawings, in which:

FIG. 1 is a block diagram of a computing device for generating light field data from stereo images according to one embodiment of the present disclosure;

FIG. 2 is a flowchart of a disparity estimation process according to one embodiment of the present disclosure;

FIG. 3 is a schematic diagram of the disparity estimation process according to one embodiment of the present disclosure;

FIG. 4 is a flowchart of a view extrapolation process according to one embodiment of the present disclosure;

FIG. 5 is a schematic diagram illustrating a retinal offset between two subviews projected from neighboring micro-projectors;

FIG. 6 is a schematic diagram showing an example configuration of the micro-projector arrays;

FIG. 7 is a schematic diagram of the weight map according to one embodiment of the present disclosure;

FIG. 8 is a flowchart of the light field refinement process according to one embodiment of the present disclosure;

FIG. 9 is a flowchart of the intra-view compensation process and the inter-view compensation process according to one embodiment of the present disclosure;

FIG. 10 is a schematic diagram showing the projection of a light field onto human eye from two adjacent micro-projectors according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

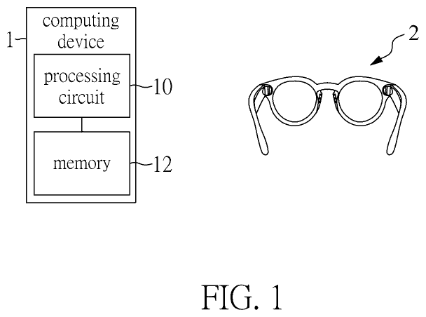

FIG. 1 is a block diagram of a computing device for generating light field data from stereo images according to one embodiment of the present disclosure. Referring to FIG. 1, one embodiment of the present disclosure provides a computing device 1 for generating light field data from stereo images, and the light field data is displayable on a near-eye light field display 2. More specifically, the computing device for generating light field data is applied to a monocular light field display or a binocular light field display.

The computing device 1 includes a processing circuit 10 and a memory 12 electrically connected to the processing circuit 12.

In some embodiments, the processing circuit 10 can include one or more general-purpose processors (e.g., a central processing unit, CPU), graphic processing units (GPU), digital signal processors (DSP), or an application-specific integrated circuit (ASIC) specifically designed for light field generation. For example, the computing device 1 may be implemented as a mobile processor platform equipped with an SoC that integrates both CPU and GPU cores, or a dedicated edge computing module.

The memory 12 may be a dynamic random-access memory (DRAM) device, such as LPDDR5, suitable for real-time image processing. In another example, the memory 12 may further include a non-volatile memory component (e.g., flash memory or eMMC storage) configured to store pre-trained neural network models used for disparity estimation and refinement.

The near-eye light field display 2 can include a plurality of micro-projectors arranged in a two-dimensional array to emit light rays corresponding to individual subviews of the generated light field data. Each subview is projected through an optical waveguide toward the user's eye, thereby forming a spatially and angularly consistent light field on the retina of the user.

In this embodiment, the present disclosure provides a method for generating target light field data from a pair of stereo images. The method includes at least two steps performed by the computing device 1: generating target light field data from stereo images and make an angular sampling structure of the target light field data consistent with an internal angular sampling structure of the near-eye light field display 2, and compensating the target light field data for optical distortions of the near-eye light field display 2. In addition, the processing circuit 10 can be further configured to make a spatial resolution of the target light field data consistent with a spatial resolution of the near-eye light field display 2 and make an interpupillary distance of the target light field data consistent with an interpupillary distance of the near-eye light field display 2.

Further, the step of generating target light field data from a pair of stereo images can include three key steps: a disparity estimation process, a view extrapolation process and a light field refinement process. In short, from the stereo inputs, the disparity estimator constructs disparity maps, which are then used to extrapolate novel views surrounding each of the original stereo views. Finally, a refinement network is applied to the novel views to enhance the display quality of the light field.

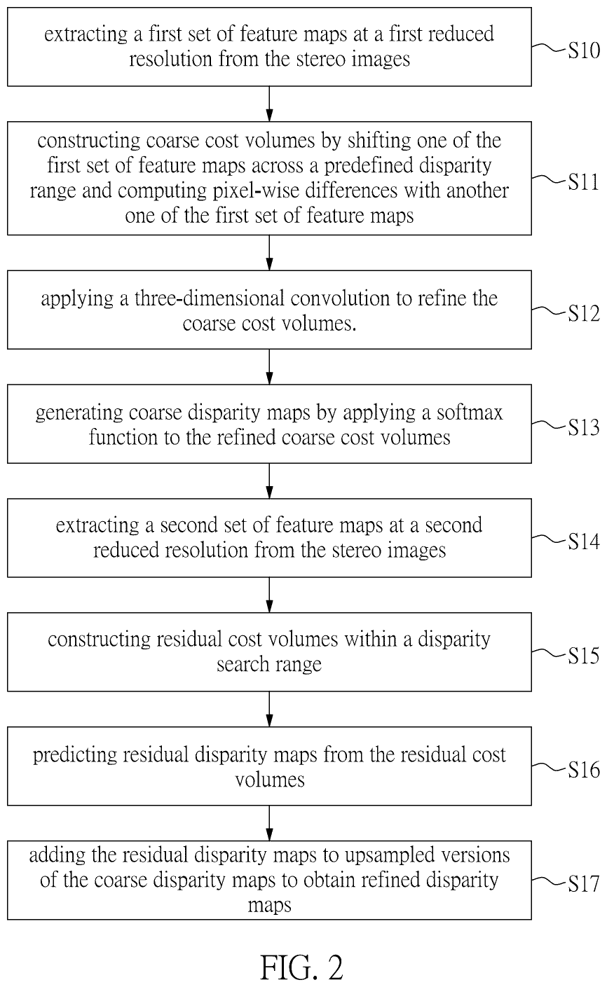

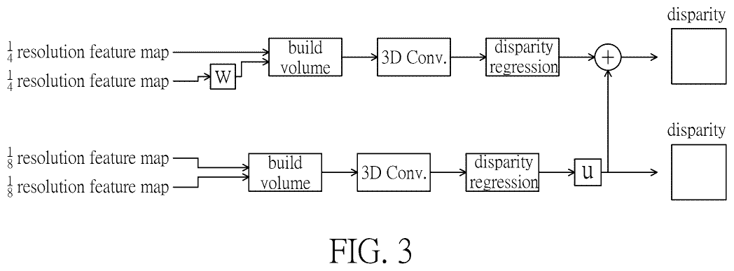

FIG. 2 is a flowchart of the disparity estimation process according to one embodiment of the present disclosure, and FIG. 3 is a schematic diagram of the disparity estimation process according to one embodiment of the present disclosure. Referring to FIGS. 2 and 3, the disparity estimation process includes a coarse disparity estimation (steps S10 to S13) and a residual disparity refinement (S14 to S17).

The pair of stereo images include left and right input images, which are denoted by I^{l}(x,y) and I^{r}(x,y), respectively, each of size H×W. The two input images are converted to a pair of light fields L(u,v,x,y) and R(u,v,x,y), (also referred to as target light field data, L and R for short), each consisting of sparse N×N subviews of the same size. The subviews of L and R are respectively denoted by L_{u,v}(x,y) and R_{u,v}(x,y), or L_{u,v} and R_{u,v} for short, where

$$- ⌊ \frac{N}{2} ⌋ \leq u , v \leq ⌊ \frac{N}{2} ⌋$$

are the angular coordinates of the light fields assuming N is an odd number. The light fields \hat{L} and \hat{R} before refinement are generated by merging subviews

$$( {L}_{u , v}^{l} , {L}_{u , v}^{r} ) and ( {R}_{u , v}^{l} , {R}_{u , v}^{r} ) .$$

The superscript in the notation indicates the source input image (left or right) from which each subview is warped.

Step S10: extracting a first set of feature maps at a first reduced resolution from the stereo images.

Given a pair of stereo images, each of size H×W, a cost volume of size M×H×W is constructed, where M denotes the maximum possible disparity value or the disparity search range. The disparity of each pixel on a disparity map is estimated by calculating the minimum matching cost.

Step S11: constructing coarse cost volumes by shifting one of the first set of feature maps across a predefined disparity range and computing pixel-wise differences with another one of the first set of feature maps.

Since the virtual content to be displayed on a near-eye light field display typically is at a moderate distance, a small M is used in our model to quickly rule out uncommon disparity values while avoiding heavy computation. Therefore, a U-Net is employed to downsample and extract feature maps of ⅛ and ¼ of the original input resolution from the input images to build cost volumes of small dimensions. The cost volumes are then converted to disparity maps through the two-stage stereo matching network.

In step S11, the ⅛ resolution feature maps are taken to build the left cost volume C^{l}(m, x, y) of size

$$\frac{1}{8} M \times \frac{1}{8} H \times \frac{1}{8} W$$

to generate the coarse disparity maps, where the index m denotes a disparity value within the search range

$$[ 0 , \frac{1}{8} M ] .$$

The cost volume is built by shifting the right feature map by one pixel horizontally for

$$\frac{1}{8} M$$

times and calculating the L1 difference between the two feature maps each time. It should be noted that the cost volume is a commonly used data structure for stereo matching. For each pair of pixels, the matching cost is computed for each possible disparity within the search range.

Step S12: applying a three-dimensional convolution to refine the coarse cost volumes.

In steps S12, a 3D convolution can be applied to finetune the coarse cost volumes and learn the correlation between pixels across multiple disparity levels.

Step S13: generating coarse disparity maps by applying a softmax function to the refined coarse cost volumes.

In step S13, the coarse disparity map is generated through regression, which computes the weighted average of the disparity for each pixel, as depicted by the following equation:

$${D}^{l} ( x , y ) = {\sum }_{m = 0}^{\frac{1}{8} M} m \cdot σ ( - {C}^{l} ( m , x , y ) ) ,$$

where σ(·) is the softmax function. The same procedure is applied to obtain the right cost volume C^{r}(m,x,y) and the right disparity map D^{r} with the right input image I^{r} as the reference.

Step S14: extracting a second set of feature maps at a second reduced resolution from the stereo images.

Step S15: constructing residual cost volumes within a disparity search range.

Step S16: predicting residual disparity maps from the residual cost volumes.

Step S17: adding the residual disparity maps to upsampled versions of the coarse disparity maps to obtain refined disparity maps.

In the residual disparity refinement (S14 to S17), the ¼ resolution feature maps are used to restore image details. To speed up the residual disparity refinement, the residual disparity offsets are generated instead of a full disparity map to limit the disparity search range of the cost volume to [0, 2]. The small search range results in a small cost volume of size 3×¼H×¼W. The residual disparity map is then added to the up-scaled disparity map obtained in the residual disparity refinement for image quality preservation. By reusing the extracted features, the average computation time is about 20 ms in total for both 512×512 disparity maps D^{k} and D^{r}.

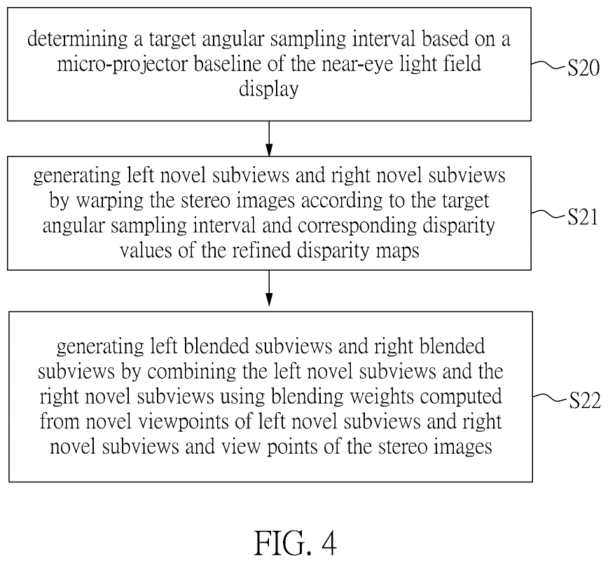

FIG. 4 is a flowchart of the view extrapolation process according to one embodiment of the present disclosure. Referring to FIG. 4, the view extrapolation process includes the following steps:

Step S20: determining a target angular sampling interval based on a micro-projector baseline of the near-eye light field display.

Step S21: generating left novel subviews and right novel subviews by warping the stereo images according to the target angular sampling interval and corresponding disparity values of the refined disparity maps.

Step S22: generating left blended subviews and right blended subviews by combining the left novel subviews and the right novel subviews using blending weights computed from novel viewpoints of left novel subviews and right novel subviews and viewpoints of the stereo images.

In the view extrapolation process, subview extrapolation is employed by display-oriented view synthesis to generate novel views compliant with the optical characteristics of the AR glasses. The near-eye light field display 2 contains an array of N×N micro-projectors for each eye, and the distance between adjacent micro-projectors is referred to as a micro-projector baseline. Each micro-projector emits light rays representing a subview of the light field, and all subviews enter the user's eye through a light guide.

Consider a thin lens model

$$\frac{1}{f} = \frac{1}{z} + \frac{1}{q}$$

for image formation, where f denotes the focal length of a human eye, z the object distance, and q the pupil-to-retina distance of the human eye, all measured with respect to the lens center of the human eye.

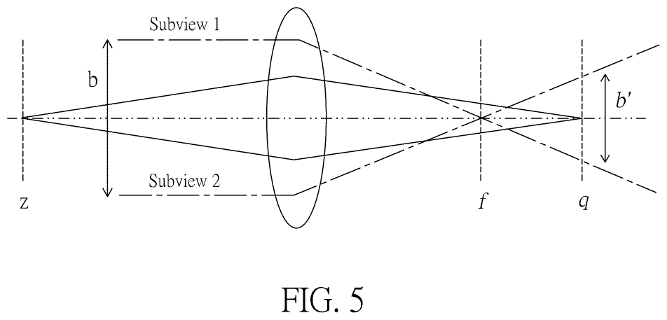

FIG. 5 is a schematic diagram illustrating a retinal offset between two subviews projected from neighboring micro-projectors. As shown in FIG. 5, two subviews projected from two adjacent micro-projectors with baseline b form two images on the retina with the distance b′ between them. The distance b′ can be represented by the following equation:

$${b}^{′} = \frac{f}{z - f} b .$$

when we focus or a user changes from a near object to infinity, b′ changes from an initial value to 0. At a certain value, the light rays of a virtual object intersect at the retina, and the virtual object appears in focus. At other values, the light rays separate on the retina, and the virtual object appears blurry.

In step S21, novel subviews are generated by warping the input image with respect to the viewpoint of the novel subview. Because of the relation described above, the configuration of viewpoints has to be consistent with that of the near-eye light field display, otherwise the light rays projected from the micro-projectors would lead to images with an incorrect sense of focus on the retina.

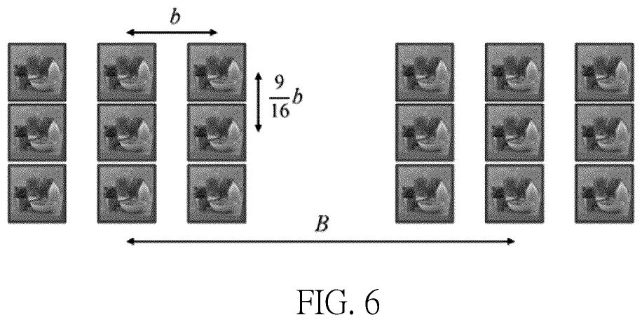

FIG. 6 is a schematic diagram showing an example configuration of the micro-projector arrays. Referring to FIG. 6, B denotes the baseline of the input stereo images and is equal to the interpupillary distance of the near-eye light field display. Since the aspect ratio of the light field display is 16:9, the horizontal and vertical micro-projector baseline are b and

$$\frac{9}{16} b ,$$

respectively. Accordingly, the horizontal and vertical distances between adjacent novel viewpoints are also set to b and

$$\frac{9}{16} b ,$$

respectively.

Given the novel viewpoint, a novel subview is warped from an input image by shifting each pixel of the input image by the distance equal to the corresponding disparity value. The amount of shift for each pixel of the input image can be obtained by multiplying the angular sampling interval of light field by D^{l}/B for left subviews (or D^{r}/B for right subviews).

Therefore, each subview

$${L}_{u , v}^{l}$$

of the left light field is warped from the left input image I^{l} and the left disparity map D^{l} by the following equation:

$${L}_{u , v}^{l} ( x , y ) = {I}^{l} ( x + u \cdot b \cdot \frac{{D}^{l} ( x , y )}{B} , y + v \cdot \frac{9}{16} b \cdot \frac{{D}^{l} ( x , y )}{B} ) .$$

The superscript of

$${L}_{u , v}^{l}$$

indicates that it is the left input image that the subview is warped from. Each subview

$${R}_{u , v}^{r}$$

of the right intermediate light field is warped from the right input image I^{r} in a similar way by using D^{r}.

One common practice in view synthesis is to form a novel subview by blending the subviews warped from different input images. Because the input images are captured from different viewpoints, objects occluded in one viewpoint may be visible in other viewpoints, making realistic subview synthesis possible.

The weight map for determining the contribution of each input view to a novel view can be obtained by either a learning-based method or a distance-based method. The learning-based method requires the use of an extra neural network, while the distance-based method allows the weights to be pre-calculated. For efficiency, the distance-based method is utilized. The closer a novel viewpoint is to an input viewpoint, the more weight the corresponding subview receives in the subview blending process.

The viewpoints are mapped out according to the micro-projector configuration illustrated in FIG. 6. The coordinates of a novel viewpoint of the left subview are denoted by the vector

$${p}_{u , v}^{l}$$

and that of the right subview are denoted by

$${p}_{u , v}^{r} .$$

The coordinates of the left input viewpoint are denoted by η^{l} and that of the right input viewpoint are denoted by η^{r}. The weight

$${a}_{u , v}^{l}$$

for blending the left subviews at the angular coordinates (u,v) is computed by the following equation:

$${a}_{u , v}^{l} = \frac{‖ {p}_{u , v}^{l} - {η}^{r} ‖}{‖ {p}_{u , v}^{l} - {η}^{l} ‖ + ‖ {p}_{u , v}^{l} - {η}^{r} ‖} .$$

This is calculated from the distance between the novel viewpoint and the input image's viewpoint. If a novel viewpoint

$$( {p}_{u , v}^{l} or {p}_{u , v}^{r} )$$

is closer to η^{l}, its corresponding subview shares more similarity to the left input image, and vice versa.

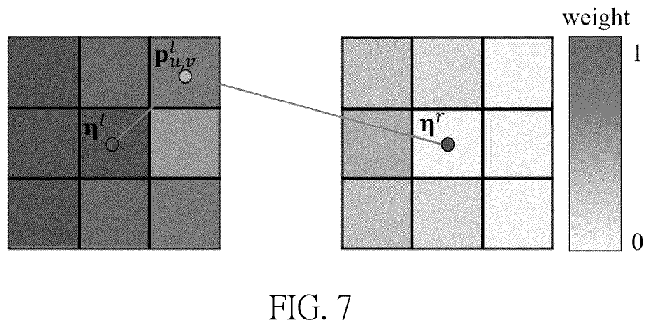

FIG. 7 is a schematic diagram of the weight map according to one embodiment of the present disclosure.

In order to make the merged subviews of the left light field contain information from both input images, another left intermediate light field L^{r} with subviews warped from I^{r} and D^{r} is generated. Each subview of L^{r} is warped by the following equation:

$${L}_{u , v}^{r} ( x , y ) = {I}^{r} ( x + ( u \cdot b + B ) \cdot \frac{{D}^{r} ( x , y )}{B} , y + v \cdot \frac{9}{16} b \cdot \frac{{D}^{r} ( x , y )}{B} ) .$$

Furthermore, the subviews \hat{L}_{u,v} of the left light field are obtained by blending

$${L}_{u , v}^{l} and {L}_{u , v}^{r} ,$$

as depicted by the following equation:

$${\hat{L}}_{u , v} = {L}_{u , v}^{l} {a}_{u , v}^{l} + {L}_{u , v}^{r} ( 1 - {a}_{u , v}^{l} ) .$$

The subviews \hat{R}_{u,v} of the right light field can be generated in a similar way using

$${R}_{u , v}^{l} and {R}_{u , v}^{r} .$$

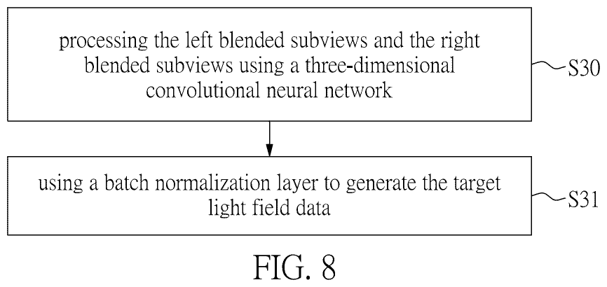

FIG. 8 is a flowchart of the light field refinement process according to one embodiment of the present disclosure. Referring to FIG. 8, the light field refinement process includes the following steps:

Step S30: processing the left blended subviews and the right blended subviews using a three-dimensional convolutional neural network.

Step S31: using a batch normalization layer to generate the target light field data.

In steps S30 and S31, a refinement network can be utilized to exploit the parallax structure of the light fields for quality enhancement and handles occlusion boundaries and non-Lambertian effect in the subviews. A natural approach to the refinement employs a 4-D convolutional network that spans both the spatial and angular dimensions. However, 4-D convolution comes with a considerable computational cost, impractical for many real-world applications. In order to balance image quality and speed, the refinement network is simplified in the present disclosure to only one layer of 3D CNN and a batch normalization layer with kernel size of one. All 2×N×N subviews of \hat{L}_{u,v} and \hat{R}_{u,v} are processed by the network at the same time to ensure the photometric consistency between them. The simplified refinement network generates the output light fields L and R while maintaining the speed performance of the method of the present disclosure. The resulting light field matches the optical characteristics of the near-eye light field display. This is achieved by computing the viewpoint of each novel subview of the light field according to the micro-projector baseline of the light field display and extrapolating novel subviews in accordance with the angular sampling interval obtained.

After the target light field data is generated, an intra-view compensation process and an inter-view compensation process are performed to compensate the target light field data for the optical distortions of the near-eye light field display 2.

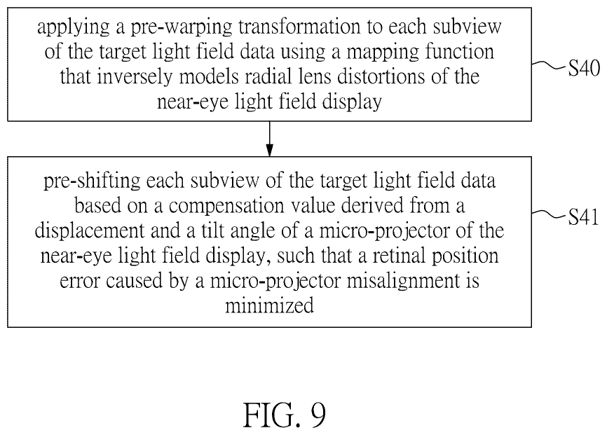

FIG. 9 is a flowchart of the intra-view compensation process and the inter-view compensation process according to one embodiment of the present disclosure. Referring to FIG. 9, the present disclosure further provides a post-synthesis process that digitally compensates for the visual distortion caused by the optical artifact of light field displays, such as lens distortion and micro-projector misalignment. Lens distortion results in image deformation, while micro-projector misalignment results in image blur and distortion. The operation that counteracts lens distortion of each micro-projector is referred to as “intra-view compensation” and the operation that counteracts misalignment between micro-projectors is referred to as “inter-view compensation.” These operations are applied to both light fields L and R. For simplicity, only the compensation process for L is described. As shown in FIG. 9, the following steps are performed by the computing device 1:

Step S40: applying a pre-warping transformation to each subview of the target light field data using a mapping function that inversely models radial lens distortions of the near-eye light field display.

Mathematically, the intra-view compensation is represented by a mapping function Q(·) as the inverse of lens distortion. The mapping function undistorts an image beforehand to cancel out the image distortion introduced later by the optical system. The mapping is determined from the point correspondences between the distorted and the undistorted checkerboard patterns obtained in a calibration procedure.

Let y be the coordinates of a point in an undistorted image and γ′ the coordinates of the point in a distorted image. Then, the effect of radial lens distortion on the image can be described by γ′=(1+k₁r²+k₂r⁴)γ, where k₁, k₂ are coefficients and r=∥γ∥. Using n pairs of corresponding corner points of the undistorted and distorted checkerboard patterns, k₁ and k₂ can be solved by finding a least-squared solution for the linear system. Then, coefficients of the mapping function [symbol] (·) in terms of k₁, k₂ by series reversion are obtained. The effect of intra-view compensation by pre-warping subviews is expressed as:

$${γ}^{″} = [ 1 - {k}_{1} {r}^{2} + ( 3 {k}_{1}^{2} - {k}_{2} ) {r}^{4} - 4 ( 3 {k}_{1}^{3} - 2 {k}_{1} {k}_{2} ) {r}^{6} + O ( {r}^{6} ) ] γ ,$$

where γ″ is the coordinates of points in a pre-warped subview. The equation is analyzed up to precision O(r⁶) and neglects higher-order terms beyond this level.

Step S41: pre-shifting each subview of the target light field data based on a compensation value derived from a displacement and a tilt angle of a micro-projector of the near-eye light field display, such that a retinal position error caused by a micro-projector misalignment is minimized.

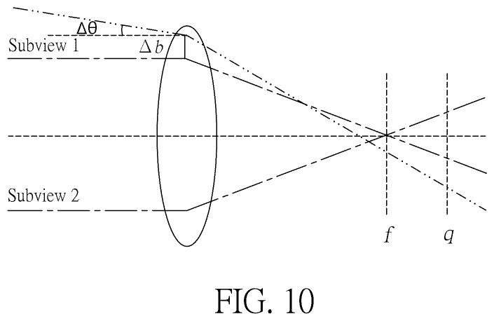

The inter-view compensation in step S41 is a critical step for light field display. The misalignment of each micro-projector is characterized by a displacement and a tilt angle of its optical axis. FIG. 10 is a schematic diagram showing the projection of a light field onto human eye from two adjacent micro-projectors according to one embodiment of the present disclosure.

Consider the example shown in FIG. 10. The top micro-projector is misaligned, whose chief ray has an offset of Δb and a tilt angle Δθ with respect to the ideal optical axis.

Using ray transfer matrix, the formation of a subview image on the retina can be expressed as:

$$[ \begin{matrix}1 & f \\ 0 & 1\end{matrix} ] [ \begin{matrix}1 & 0 \\ - \frac{1}{α f} & 1\end{matrix} ] [ \begin{matrix}\frac{b}{2} + Δ b \\ Δθ\end{matrix} ] = [ \begin{matrix}\frac{b}{2} ( 1 - \frac{1}{α} ) \\ - \frac{b}{2 α f}\end{matrix} ] + [ \begin{matrix}f Δθ + ( 1 - \frac{1}{α} ) Δ b \\ Δθ - \frac{Δ b}{α f}\end{matrix} ] ,$$

where f is the focal length of the eye when focusing at infinity and α is a scale factor, 0<α≤1. Normally, the eye focuses at a depth shorter than infinity; therefore, f is multiplied with a to represent the general case. In the above equation, a tilt angle Δθ and an offset Δb of a micro-projector result in a vertical position error on the retina when the human eye accommodates for an object at a distance, and the horizontal position error can be expressed in a similar way.

The vertical position error can be represented by the following equation:

$$E ( α ) = f Δθ + ( 1 - \frac{1}{α} ) Δ b .$$

Inter-view compensation involves pre-shifting each subview to reduce the retinal position error of the subview image. In the case where there is no tilt error (Δθ=0), the compensation involves shifting the subview by −Δb to compensate for the position error

$$( 1 - \frac{1}{α} ) Δ b$$

produced by the micro-projector misalignment. The angular error is tolerable as long as the light rays hit the target position on the retina.

In the presence of tilt error, the compensation value for a subview is dependent on Δ, which means a different compensation value needs to be computed as the eye changes its focal point. For practical purposes, a fixed compensation is selected by a constant value in disregard of the focus depth of the user.

Considering two images of the subview: one is formed with the smallest value α₁ and another with the largest value α₂. The corresponding position errors due to micro-projector misalignment are E(α₁) and E(α₂), as shown in FIG. 10.

One objective is to minimize the total position error for all α's within the range [α₁, α₂], the scale factor a is assumed to follow a uniform distribution as the eye navigates through a scene.

Mathematically, it can be formulated as finding a value E(αₕ) that minimizes the total error:

$${\int }_{{α}_{1}}^{{α}_{2}} \vert E ( α ) - E ( {α}_{h} ) \vert d α .$$

Substituting E(α) to the above equation yields the integral:

$$Δ b = [ 2 ln ( {α}_{h} ) - 2 + \frac{{α}_{1} + {α}_{2}}{{α}_{h}} - ln ( {α}_{1} ) - ln ( {α}_{2} ) ] .$$

The integral is minimal when αₕ=(α₁+α₂)/2.

The corresponding compensation value ΔB for the subview is shown in the following equation:

$$Δβ = \frac{{α}_{h} f Δθ}{1 - {α}_{h}} - Δ b .$$

The image quality and speed performance of the method of the present disclosure are compared against other view synthesis methods. Peak signal-to-noise-ratio (PSNR), structural similarity index measure (SSIM), and learned perceptual image patch similarity (LPIPS) are used as the quality metrics for the refocused images.

In conclusion, in the computing device and the method for generating light field data from stereo images provided by the present disclosure, an innovative approach consisting of light field synthesis and digital compensation is utilized to efficiently convert 3D stereo contents to light field data suitable for near-eye light field display.

Furthermore, the computing device and the method for generating light field data from stereo images provided by the present disclosure further utilize a lightweight synthesis model having a low parameter count critical to real-time inference on mobile devices, and the compensation technique utilized can rectify the light field to compensate the optical misalignment of the near-eye light field display for minimal retinal error, thereby ensuring a high-quality light field perception.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A computing device for generating light field data displayable on a near-eye light field display, the computing device applied to a monocular light field display or a binocular light field display, the computing device comprising one or more processing units configured to:
generate target light field data from stereo images and make an angular sampling structure of the target light field data consistent with an internal angular sampling structure of the near-eye light field display; and
compensate the target light field data for optical distortions of the near-eye light field display.

2. The computing device according to claim 1, wherein the one or more processing units are further configured to make a spatial resolution of the target light field data consistent with a spatial resolution of the near-eye light field display for the monocular light field display and the binocular light field display, and to make an interpupillary distance of the target light field data consistent with the interpupillary distance of the near-eye light field display for the binocular light field display.

3. The computing device according to claim 2, wherein generating the target light field data from the stereo images includes performing a disparity estimation process, a view extrapolation process, and a light field refinement process.

4. The computing device according to claim 3, wherein the disparity estimation process includes a coarse disparity estimation and a residual disparity refinement, and the coarse disparity estimation includes:
extracting a first set of feature maps at a first reduced resolution from the stereo images;
constructing coarse cost volumes by shifting one of the first set of feature maps across a predefined disparity range and computing pixel-wise differences with another one of the first set of feature maps;
applying a three-dimensional convolution to refine the coarse cost volumes; and
generating coarse disparity maps by applying a softmax function to the coarse cost volumes that are refined.

5. The computing device according to claim 4, wherein the residual disparity refinement includes:
extracting a second set of feature maps at a second reduced resolution from the stereo images;
constructing residual cost volumes within a disparity search range;
predicting residual disparity maps from the residual cost volumes; and
adding the residual disparity maps to upsampled versions of the coarse disparity maps to obtain refined disparity maps.

6. The computing device according to claim 5, wherein the view extrapolation process includes:
determining a target angular sampling interval based on a micro-projector baseline of the near-eye light field display;
generating left novel subviews and right novel subviews by warping the stereo images according to the target angular sampling interval and corresponding disparity values of the refined disparity maps; and
generating left blended subviews and right blended subviews by combining the left novel subviews and the right novel subviews using blending weights computed from novel viewpoints of left novel subviews and right novel subviews and viewpoints of the stereo images.

7. The computing device according to claim 6, wherein the light field refinement process includes:
processing the left blended subviews and the right blended subviews using a three-dimensional convolutional neural network followed by a batch normalization layer to generate the target light field data.

8. The computing device according to claim 1, wherein compensating the target light field data for the optical distortions of the near-eye light field display includes performing an intra-view compensation process and an inter-view compensation process.

9. The computing device according to claim 8, wherein the intra-view compensation process includes:
applying a pre-warping transformation to each subview of the target light field data using a mapping function that inversely models radial lens distortions of the near-eye light field display.

10. The computing device according to claim 8, wherein the inter-view compensation process includes:
pre-shifting each subview of the target light field data based on a compensation value derived from a displacement and a tilt angle of a micro-projector of the near-eye light field display, such that a retinal position error caused by a micro-projector misalignment is minimized.

11. A method for generating light field data displayable on a near-eye light field display, the method comprising:
configuring one or more processing units to:
generate target light field data from stereo images and make an angular sampling structure of the target light field data consistent with an internal angular sampling structure of the near-eye light field display; and
compensate the target light field data for optical distortions of the near-eye light field display.

12. The method according to claim 11, wherein the one or more processing units are further configured to make a spatial resolution of the target light field data consistent with a spatial resolution of the near-eye light field display.

13. The method according to claim 12, wherein generating the target light field data from the stereo images includes performing a disparity estimation process, a view extrapolation process, and a light field refinement process.

14. The method according to claim 11, wherein the disparity estimation process includes a coarse disparity estimation and a residual disparity refinement, and the coarse disparity estimation includes:
extracting a first set of feature maps at a first reduced resolution from the stereo images;
constructing coarse cost volumes by shifting one of the first set of feature maps across a predefined disparity range and computing pixel-wise differences with another one of the first set of feature maps;
applying a three-dimensional convolution to refine the coarse cost volumes; and
generating coarse disparity maps by applying a softmax function to the refined coarse cost volumes.

15. The method according to claim 14, wherein the residual disparity refinement includes:
extracting a second set of feature maps at a second reduced resolution from the stereo images;
constructing residual cost volumes within a disparity search range;
predicting residual disparity maps from the residual cost volumes; and
adding the residual disparity maps to upsampled versions of the coarse disparity maps to obtain refined disparity maps.

16. The method according to claim 15, wherein the view extrapolation process includes:
determining a target angular sampling interval based on a micro-projector baseline of the near-eye light field display;
generating left novel subviews and right novel subviews by warping the stereo images according to the target angular sampling interval and corresponding disparity values of the refined disparity maps; and
generating left blended subviews and right blended subviews by combining the left novel subviews and the right novel subviews using blending weights computed from novel viewpoints of left novel subviews and right novel subviews and viewpoints of the stereo images.

17. The method according to claim 16, wherein the light field refinement process includes:
processing the left blended subviews and the right blended subviews using a three-dimensional convolutional neural network followed by a batch normalization layer to generate the target light field data.

18. The method according to claim 12, wherein compensating the target light field data for the optical distortions of the near-eye light field display includes performing an intra-view compensation process and an inter-view compensation process.

19. The method according to claim 18, wherein the intra-view compensation process includes:
applying a pre-warping transformation to each subview of the target light field data using a mapping function that inversely models radial lens distortions of the near-eye light field display.

20. The method according to claim 18, wherein the inter-view compensation process includes:
pre-shifting each subview of the target light field data based on a compensation value derived from a displacement and a tilt angle of a micro-projector of the near-eye light field display, such that a retinal position error caused by a micro-projector misalignment is minimized.
